(19) United States
(12) Patent Application Publication
(10) Pub. No.: US 2023/0082901 A1
(43) Pub. Date: Mar. 16, 2023

(54) RECIPROCATING CUTTING TOOL

(71) Applicant: MAKITA CORPORATION, Anjo-shi (JP)

(72) Inventors: Tomofumi KAWAI, Anjo-shi (JP); Shinnosuke BABA, Anjo-shi (JP)

(73) Assignee: MAKITA CORPORATION, Anjo-shi (JP)

(21) Appl. No.: 17/892,457

(22) Filed: Aug. 22, 2022

(30) Foreign Application Priority Data
Sep. 10, 2021 (JP) 2021-148044

(51) Int. Cl. B23D 49/16; B23D 51/16

(52) U.S. Cl. CPC B23D 49/162; B23D 51/16

(57) ABSTRACT

A reciprocating cutting tool allows a more stable operation. A reciprocating saw includes a motor extending vertically, a reciprocating transmitter located below the motor, a slider extending in a front-rear direction, connected to the reciprocation transmitter, and movable in the front-rear direction, a power housing holding the motor and the reciprocation transmitter, a grip housing extending rearward from the power housing, a battery housing located behind the grip housing, and a connecting housing located below the grip housing and connecting the power housing to the battery housing.

### CROSS-REFERENCE TO RELATED APPLICATIONS

This application claims the benefit of priority to Japanese Patent Application No. 2021-148044, filed on Sep. 10, 2021, the entire contents of which are hereby incorporated by reference.

### BACKGROUND

### 1. Technical Field

The present disclosure relates to a reciprocating cutting tool such as a rechargeable reciprocating saw.

### 2. Description of the Background

British Patent No. 2489865 (hereafter, Patent Literature 1) describes a reciprocating saw with a spindle shaft 240 reciprocating in the front-rear direction. The spindle shaft 240 includes a blade clamp 260 at its front end. The blade clamp 260 can be used to attach a blade 250 including a saw blade facing downward. The spindle shaft 240 is a vertical-crank spindle shaft that is driven by a motor 65 through a driven gear 215 extending in the vertical and front-rear directions. The motor 65 is located above the driven gear 215. A motor shaft 410 faces downward toward the front.

British Patent No. 2462358 (hereafter, Patent Literature 2) describes a reciprocating saw with a clamp 30 reciprocating in the front-rear direction. The clamp 30 can be used to attach a blade 18 including a saw blade facing downward. A spindle shaft 240 is a horizontal-crank spindle shaft that is driven by a motor 16 through a transmission 17 including gears extending in the front-rear and lateral directions. The motor 16 is located above the transmission 17. A motor shaft extends vertically (refer to a second central axis Y).

Cainz's Online Store Page, Electric Saw No. 100 (online), https://www.cainz.com/g/4907052377233.html (accessed Aug. 24, 2021) (hereafter, Non-Patent Literature 1) describes an electric saw including a blade extending in the front-rear direction, a housing, and an electric power cable. The housing includes a portion extending vertically above the blade and a loop handle with a grip extending in the front-rear direction at the rear of the vertical portion.

Ridgid 18 Volt Octane Cordless Brushless Single-handed Reciprocating Saw on Daiya Store (online), https://store.shopping.yahoo.co.jp/dia-store/b081d7jg1v.html (accessed Aug. 24, 2021) (hereafter, Non-Patent Literature 2) describes a reciprocating saw including a blade extending in the front-rear direction, a housing, and a battery. The housing includes a portion extending in the front-rear direction from the rear of the blade and a loop handle including a grip extending diagonally sloping downward at the rear of the portion extending in the front-rear direction.

### BRIEF SUMMARY

One or more aspects of the present disclosure are directed to a reciprocating cutting tool with a more stable operation.

A first aspect of the present disclosure provides a reciprocating cutting tool, including:

a motor extending vertically;

a reciprocating transmitter located below the motor;

a slider extending in a front-rear direction, connected to the reciprocation transmitter, and movable in the front-rear direction;

a power housing holding the motor and the reciprocation transmitter;

a grip housing extending rearward from the power housing;

a battery housing located behind the grip housing; and

a connecting housing located below the grip housing and connecting the power housing to the battery housing.

A second aspect of the present disclosure provides a reciprocating cutting tool, including:

a brushless motor extending vertically;

a reciprocation transmitter located below the brushless motor;

a slider extending in a front-rear direction, connected to the reciprocation transmitter, and movable in the front-rear direction;

a power housing holding the brushless motor and the reciprocation transmitter;

a grip housing extending rearward from the power housing; and

a connecting housing located below the grip housing and connecting the power housing to the grip housing.

A third aspect of the present disclosure provides a reciprocating cutting tool, including:

a slider extending in a front-rear direction, the slider including a tip tool holder to hold a tip tool including an acting part to act onto a workpiece, the tip tool holder being configured to hold the tip tool with the acting part facing at least upward or downward;

a motor;

a reciprocation transmitter connected to the motor and the slider to move the slider in the front-rear direction, the reciprocation transmitter including a rotator extending in the front-rear direction and in a lateral direction; and

a balancer connected to the reciprocation transmitter, movable in a direction opposite to the slider in the front-rear direction, and having a predetermined weight,

wherein in a vertical direction, a distance between an imaginary centerline of the balancer and a center of gravity of the reciprocating cutting tool is greater than a distance between an imaginary centerline of the slider and the center of gravity.

The reciprocating cutting tool according to the above aspects of the present disclosure allows a more stable operation.

### BRIEF DESCRIPTION OF DRAWINGS

FIG. 1 is a perspective view of a reciprocating saw as viewed from the upper right front.

FIG. 2 is a left side view of the reciprocating saw.

FIG. 3 is a longitudinal central sectional view of FIG. 1.

FIG. 4 is a sectional view taken along line A-A in FIG. 3.

FIG. 5 is a sectional view taken along line B-B in FIG. 3.

FIG. 6 is a sectional view taken along line C-C in FIG. 3.

FIG. 7 is a sectional view taken along line D-D in FIG. 3.

FIG. 8 is a sectional view taken along line E-E in FIG. 3.

FIG. 9 is an exploded perspective view of a slider and adjacent components in the reciprocating saw, as viewed from the upper left front.

FIG. 10 is an exploded perspective view of the slider and adjacent components in the reciprocating saw, as viewed from the lower left rear.

FIG. 11 is a partial sectional left side view of the reciprocating saw showing its dimensions.

FIG. 12 is a partial sectional left side view of the reciprocating saw when the slider moves backward near the front end of its reciprocating range.

FIG. 13 is a partial sectional left side view of the reciprocating saw when the slider moves backward near the rear end of its reciprocating range.

FIG. 14 is a partial sectional left side view of the reciprocating saw when the slider moves forward near the rear end of its reciprocating range.

FIG. 15 is a partial sectional left side view of the reciprocating saw when the slider moves forward near the front end of its reciprocating range.

### DETAILED DESCRIPTION

### Embodiments

Embodiments (including modifications) of the present disclosure will now be described with reference to the drawings as appropriate.

A reciprocating cutting tool according to the present embodiment is an example of a power tool and a reciprocating tool. More specifically, the reciprocating cutting tool according to the present embodiment is a reciprocating saw.

The directional terms such as front, rear, up, down, right, and left in the embodiments are defined for ease of explanation, and may be changed depending on, for example, at least the operating situations or the status of a movable member.

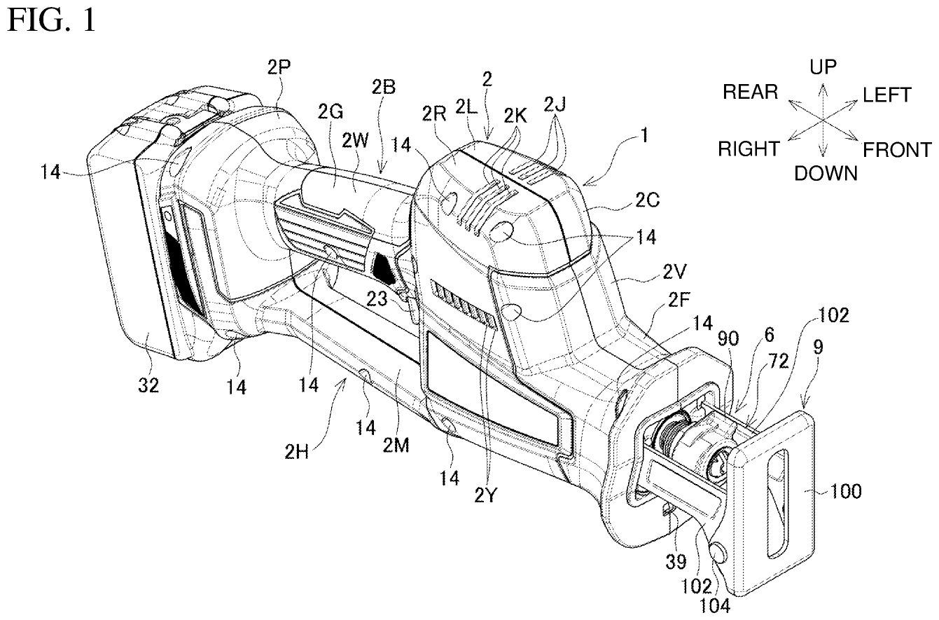

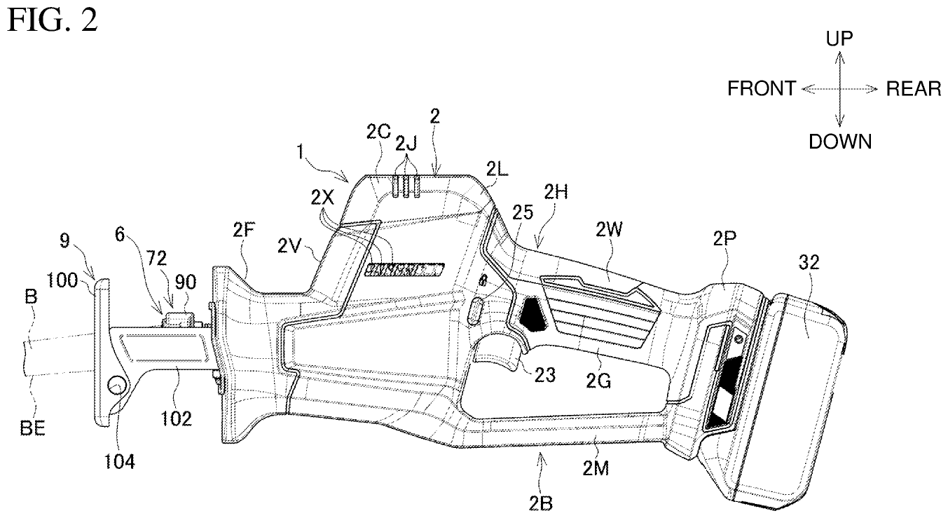

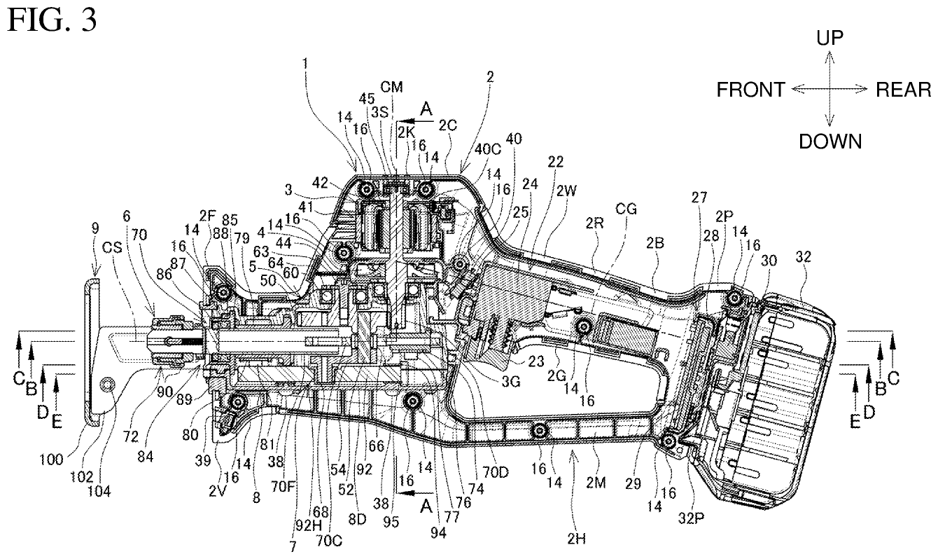

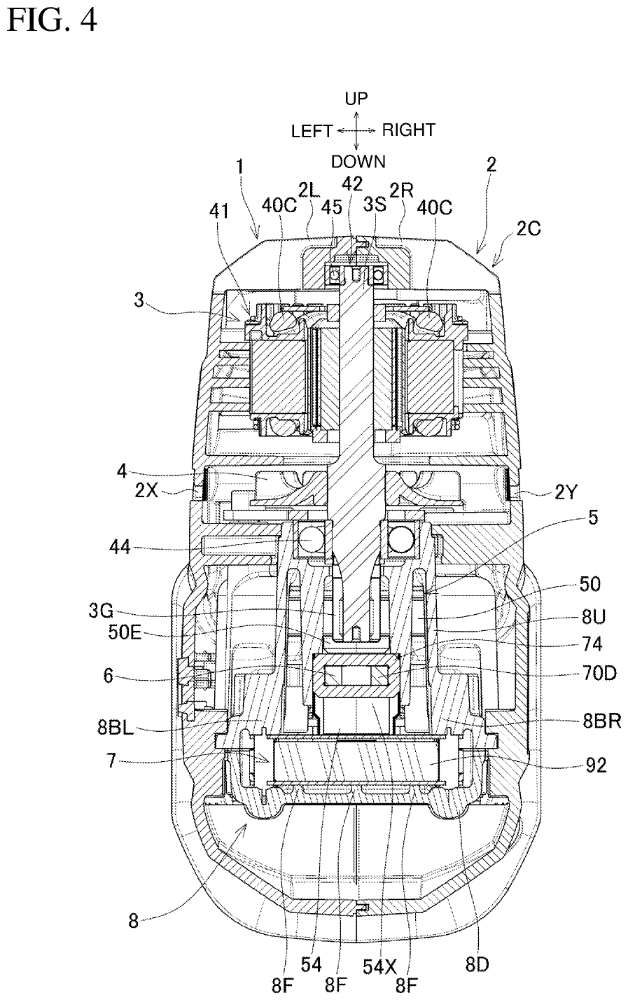

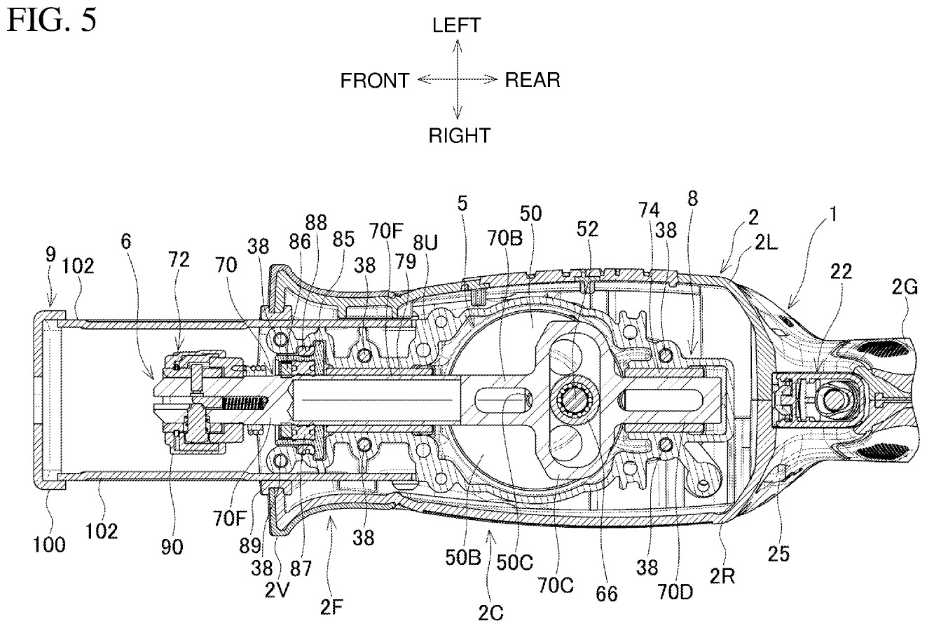

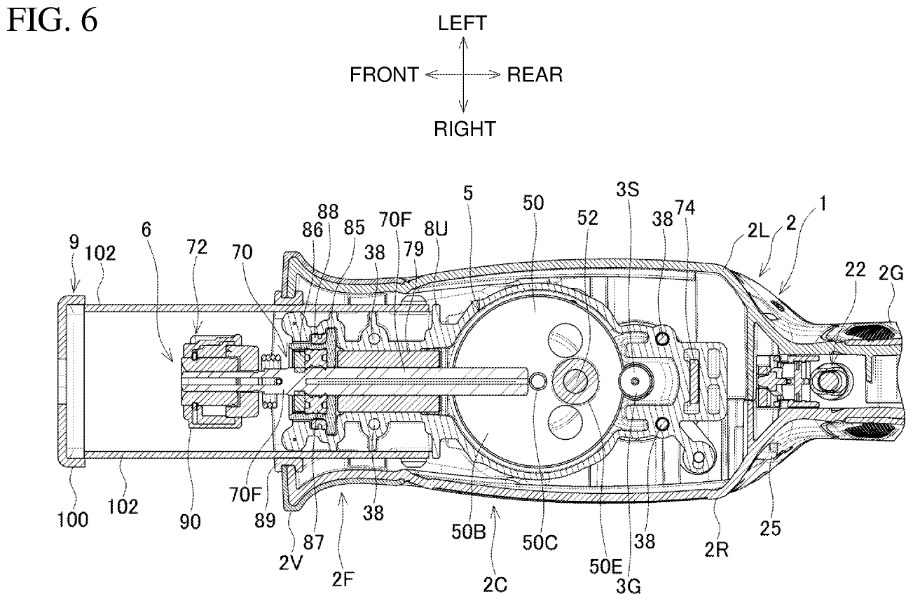

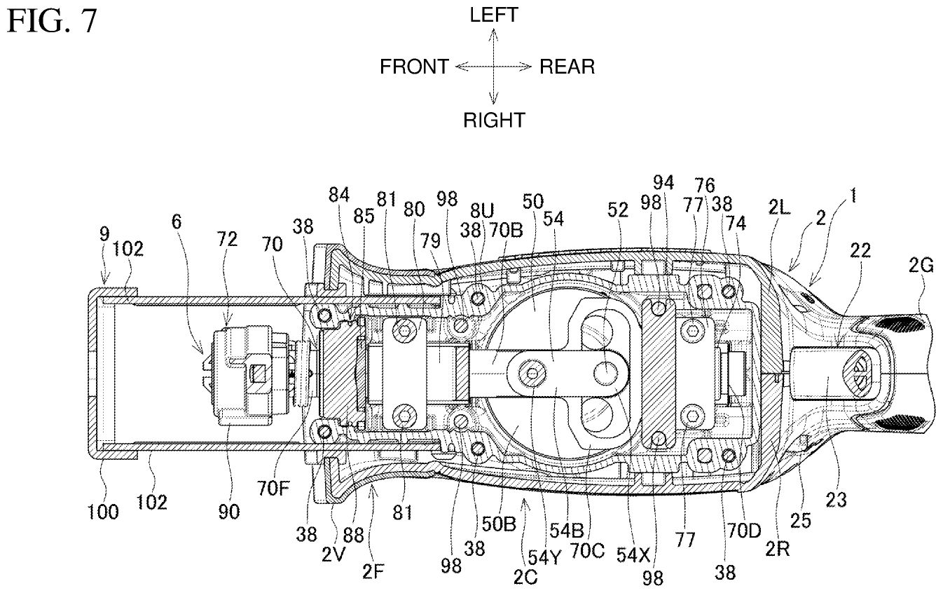

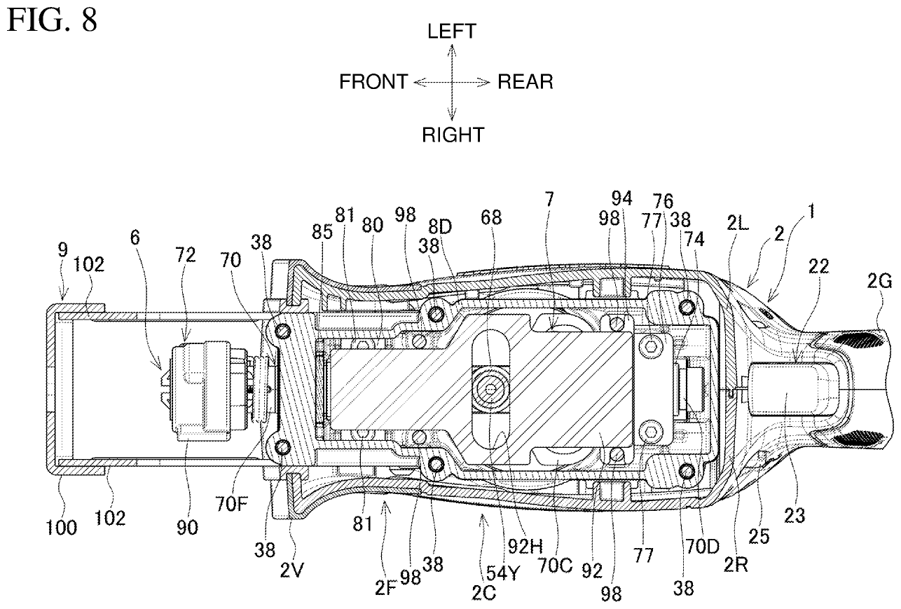

FIG. 1 is a perspective view of a reciprocating saw 1 as viewed from the upper right front. FIG. 2 is a left side view of the reciprocating saw 1. FIG. 3 is a longitudinal central sectional view of FIG. 1. FIG. 4 is a sectional view taken along line A-A in FIG. 3. FIG. 5 is a sectional view taken along line B-B in FIG. 3. FIG. 6 is a sectional view taken along line C-C in FIG. 3. FIG. 7 is a sectional view taken along line D-D in FIG. 3. FIG. 8 is a sectional view taken along line E-E in FIG. 3.

The reciprocating saw 1 includes a body housing 2, a motor 3, a fan 4, a reciprocation transmitter 5, a slider 6 as an output unit, a counterweight 7, a gear case 8, and a guide shoe 9.

The body housing 2 is a support frame that directly or indirectly holds the components.

The body housing 2 includes halves, or a left body housing 2L and a right body housing 2R.

The body housing 2 includes an output housing 2F at the front. The output housing 2F is a cylinder with open front and rear ends.

The body housing 2 includes a power housing 2C in the center. The power housing 2C is rectangular and extends vertically. The output housing 2F is joined to a lower front portion of the power housing 2C.

The body housing 2 includes a body housing rear portion 2B at the rear. The body housing rear portion 2B and the rear end of the power housing 2C are looped and define a loop handle 2H.

The body housing rear portion 2B includes, in its upper portion, a grip housing 2G grippable by a user. The grip housing 2G extends rearward and downward from the middle portion of the rear end of the power housing 2C in the vertical direction.

The body housing rear portion 2B includes a connecting housing 2M in its lower portion. The connecting housing 2M extends rearward and upward from the lower rear end of the power housing 2C. The connecting housing 2M is located below the grip housing 2G.

The body housing rear portion 2B has its rear portion serving as a battery housing 2P. The rear end of the grip housing 2G connects to a front upper portion of the battery housing 2P. The rear end of the connecting housing 2M connects to a front lower portion of the battery housing 2P. The connecting housing 2M connects the power housing 2C to the battery housing 2P.

A cover 2V is located on the outer surface of the output housing 2F and on the outer surface of a middle portion of the front end of the power housing 2C in the vertical direction. A cover 2W is located on the outer surface of the grip housing 2G and on the upper and front surface of the battery housing 2P. The covers 2V and 2W are formed from an elastic member, or specifically, an elastomer. The cover 2V is integral with the left body housing 2L. The cover 2W is integral with the right body housing 2R. The number of covers 2V and 2W and their arrangements may be changed variously. For example, at least either the cover 2V or 2W may be eliminated.

The body housing 2 holds the motor 3 inside the power housing 2C. The power housing 2C accommodates the motor 3.

The left body housing 2L includes multiple screw bosses (not shown). The right body housing 2R includes multiple threaded holes 14. The threaded holes 14 are aligned with the screw bosses. Multiple screws 16 are placed through the screw bosses and the threaded holes 14 laterally, fastening the right body housing 2R to the left body housing 2L.

The threaded holes 14, the screw bosses, and the screws 16 are also located in the connecting housing 2M. This improves the rigidity of the reciprocating saw 1, thus allowing a more stable operation.

The body housing 2 may not include halves, but may be a single unit.

The motor 3 extends vertically. The motor 3 includes a motor shaft 3S. The motor shaft 3S extends vertically.

The slider 6 is a rod extending in the front-rear direction. A slider centerline CS (output axis), which is an imaginary straight line passing through the central axis of the slider 6, is perpendicular to a motor shaft centerline CM, which is an imaginary straight line passing through the central axis of the motor shaft 3S. The reciprocating saw 1 with this structure is more compact. The slider centerline CS and the motor shaft centerline CM may intersect with each other at an angle other than 90°.

A grip centerline CG, which is an imaginary straight line passing through the central axis of the grip housing 2G, intersects with the motor shaft centerline CM in the direction from the lower rear to the upper front. The grip centerline CG is angled to face upward with respect to the slider centerline CS. This structure allows easy cutting. The connecting housing 2M is angled to face downward with respect to the slider centerline CS. The reciprocating saw 1 with this structure is more compact.

The grip housing 2G holds a main switch 22 in its front portion.

The main switch 22 includes a trigger 23 and a main switch body 24.

The trigger 23 is exposed in a front lower portion of the grip housing 2G. The user can pull (move upward) the trigger 23 with a finger. The trigger 23 is located below the main switch body 24. The trigger 23 is connected to the main switch body 24.

The main switch body 24 is located in the front portion of the grip housing 2G. The main switch body 24 is turned on or off in response to the operation on the trigger 23. The main switch body 24 is turned on when the pull of the trigger 23 reaches or exceeds a predetermined amount. The main switch body 24 outputs a signal (e.g., a resistance) that varies in accordance with the pull reaching or exceeding the predetermined amount.

The trigger 23 turns on or off the motor 3 through the main switch body 24. The trigger 23 is an operational switch for turning on or off the motor 3.

A lock-off button 25 is located on the upper front of the trigger 23. The lock-off button 25 is a laterally elongated plate.

The lock-off button 25 has its right and left portions exposed from the body housing 2. The lock-off button 25 is slidable rightward when the left portion is pressed. The lock-off button 25 is slidable leftward when the right portion is pressed.

The lock-off button 25 is slid to a right position to prevent the trigger 23 from being pulled. The motor 3 cannot be turned on in this state. The lock-off button 25 is slid to a left position to permit the trigger 23 to be pulled. The motor 3 can be turned on in this state.

The body housing 2 holds a controller 27 in the battery housing 2P. The controller 27 includes a controller case 28 and a control circuit board 29.

The controller case 28 holds the control circuit board 29. The control circuit board 29 is located in the controller case 28.

The control circuit board 29 controls the motor 3. The control circuit board 29 includes at least a microcomputer and multiple (six or twelve) switching elements.

The controller 27 is held obliquely and faces downward toward the front. The controller 27 (control circuit board 29) is perpendicular to the grip centerline CG.

The body housing 2 holds a terminal mount 30 in the battery housing 2P.

The terminal mount 30 is a plate with multiple terminals. The terminal mount 30 is located behind the controller 27. The terminal mount 30 is parallel to and in the same posture as the controller 27. Each terminal on the terminal mount 30 is electrically connected to the control circuit board 29.

The battery housing 2P receives a battery 32 that is slid obliquely upward from below. The battery 32 is slid in the vertical direction, or more specifically, perpendicular to the grip centerline CG. The battery 32 includes a battery tab 32P (FIG. 3). The attached battery 32 is locked to the battery housing 2P. The attached battery 32 is connected to the terminal mount 30. The battery 32 includes multiple battery terminals. Each battery terminal is electrically connected to the corresponding terminal on the terminal mount 30. At least either the sliding direction of the battery or the manner of locking may be changed from the examples described above.

The battery 32 is electrically connected to the motor 3 through the terminal mount 30 and the control circuit board 29. The battery 32 powers the motor 3.

The battery 32 is detached by sliding in the direction opposite to an attachment direction in response to an operation on a battery button (not shown) connected to the battery tab 32P to release the battery tab 32P locked to the battery housing 2P.

The output housing 2F supports the slider 6 and the counterweight 7 directly or indirectly.

The power housing 2C supports the reciprocation transmitter 5, the slider 6, and the counterweight 7 as well as the motor 3 directly or indirectly. The power housing 2C accommodates the reciprocation transmitter 5.

The gear case 8 holds the reciprocation transmitter 5, the slider 6, and the counterweight 7. The reciprocation transmitter 5, the slider 6, and the counterweight 7 are held in the body housing 2 with the gear case 8 in between.

The gear case 8 includes halves and rectangular with an upper front opening, an upper rear opening, and a front opening. The gear case 8 is formed from aluminum (or an alloy of aluminum). The gear case 8 may be formed from a metal other than aluminum. The gear case 8 may be eliminated.

The gear case 8 includes an upper gear case 8U and a lower gear case 8D.

The lower gear case 8D is fastened to the upper gear case 8U with multiple vertical screws 38. Each screw 38 is placed from below the lower gear case 8D.

At least the number of parts in the body housing 2 and the gear case 8, the size of each part in the body housing 2 and the gear case 8, or the shape and orientation of each part in the body housing 2 and the gear case 8 may be changed variously. For example, at least one of the output housing 2F, the power housing 2C, or the body housing rear portion 2B may be a separate housing separate from others. The output housing 2F and the power housing 2C may be collectively referred to as the power housing 2C. In the body housing rear portion 2B, at least one of the grip housing 2G, the connecting housing 2M, or the battery housing 2P may be a separate housing separate from the others. The power housing 2C may include the gear case 8. At least either the grip centerline CG or the connecting housing 2M may have the same direction as the slider centerline CS. In other words, at least either the grip centerline CG or the connecting housing 2M may be the same as or parallel to the slider centerline CS.

A lamp 39 is located in a lower front portion of the body housing 2. The lamp 39 includes a light-emitting diode (LED) board. The LED board receives an LED.

The lamp 39 emits light forward and upward. The lamp 39 can illuminate the area around the cutting position ahead of the slider 6.

The motor 3, the main switch body 24, and the lamp 39 are each electrically connected to the control circuit board 29 with multiple lead wires (not shown).

The leads connecting the motor 3 to the control circuit board 29 and the leads connecting the lamp 39 to the control circuit board 29 include a common connector 40. The connector 40 is separable from its lead wire portions on both sides and is reconnectable to the lead wire portions. The connector 40 is located between the motor 3 and the main switch 22 in the front-rear direction. The connector 40 is located adjacent to the lock-off button 25. More specifically, the connector 40 is in front of and above the lock-off button 25. The connector 40 is separated to separate the motor 3 and the lamp 39 from the control circuit board 29 without removing each lead wire connection, such as soldering.

The motor 3 is an electric motor. The motor 3 is a brushless motor. The motor 3 is driven with direct current (DC).

The motor 3 includes a stator 41 and a rotor 42.

The stator 41 is cylindrical. The stator 41 includes multiple (six) coils 40C. The body housing 2 holds the stator 41 inside an upper portion of the power housing 2C.

The rotor 42 is located inside the stator 41. The motor 3 is an inner-rotor motor. The rotor 42 includes a motor shaft 3S.

The motor shaft 3S is cylindrical and extends vertically. The motor shaft 3S is formed from a metal. The motor shaft 3S rotates on its central axis. The motor shaft 3S has its lower end placed through the upper rear opening of the gear case 8 and extending in an upper rear portion of the gear case 8. The motor shaft 3S receives a pinion gear 3G on its front end. The pinion gear 3G includes multiple teeth.

A motor lower bearing 44 is located above the pinion gear 3G. The motor lower bearing 44 surrounds a lower portion of the motor shaft 3S. The motor lower bearing 44 supports the motor shaft 3S in a manner rotatable on the axis.

The motor lower bearing 44 is held in the upper rear opening of the upper gear case 8U.

A motor upper bearing 45 surrounds the upper end of the motor shaft 3S. The motor upper bearing 45 supports the motor shaft 3S in a manner rotatable on the axis. The motor upper bearing 45 is held by the body housing 2.

Multiple left inlets 2J are located above the motor upper bearing 45 in the left body housing 2L. Each left inlet 2J extends laterally. The multiple left inlets 2J are aligned in the front-rear direction. Multiple right inlets 2K are located above the motor upper bearing 45 in the right body housing 2R. Each right inlet 2K extends laterally. The multiple right inlets 2K are aligned in the front-rear direction.

A fan 4 surrounds a middle portion of the motor shaft 3S. The fan 4 is located above the motor lower bearing 44 and below the rotor 42 and the stator 41. The fan 4 is a centrifugal fan with multiple blades. The fan 4 rotates and forces air radially outward. The fan 4 is fixed to the motor shaft 3S integrally to rotate together. The fan 4 is located on the motor shaft 3S. The fan 4 is held on the body housing 2 with the rotor 42.

Multiple left outlets 2X are located leftward from the fan 4 in the body housing 2. The multiple left outlets 2X are aligned in the front-rear direction. Multiple right outlets 2Y are located rightward from the fan 4 in the body housing 2. The multiple right outlets 2Y are aligned in the front-rear direction.

The gear case 8 is located below the fan 4.

The fan 4 may be a component of the motor 3.

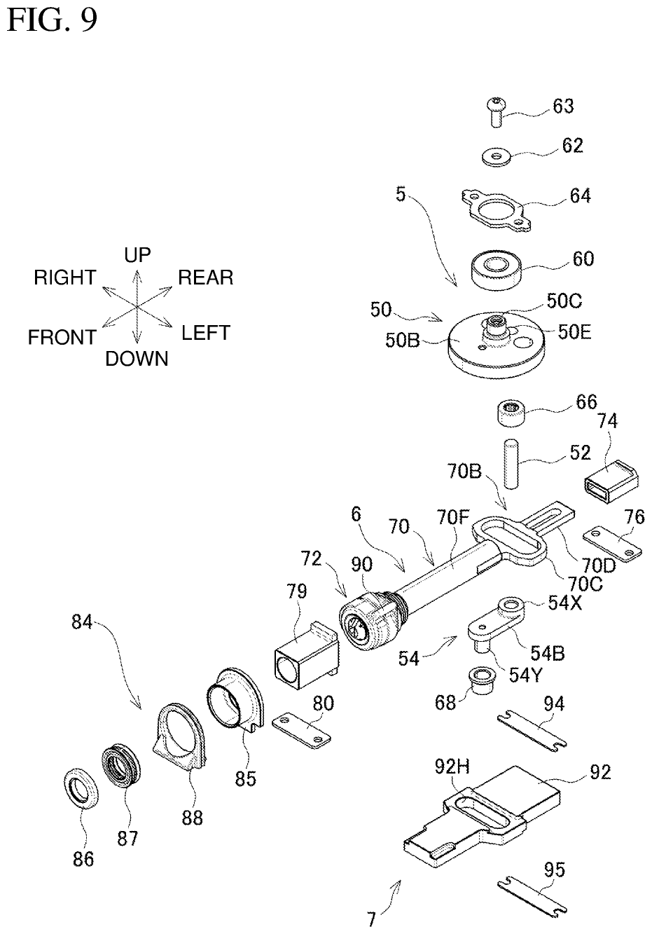

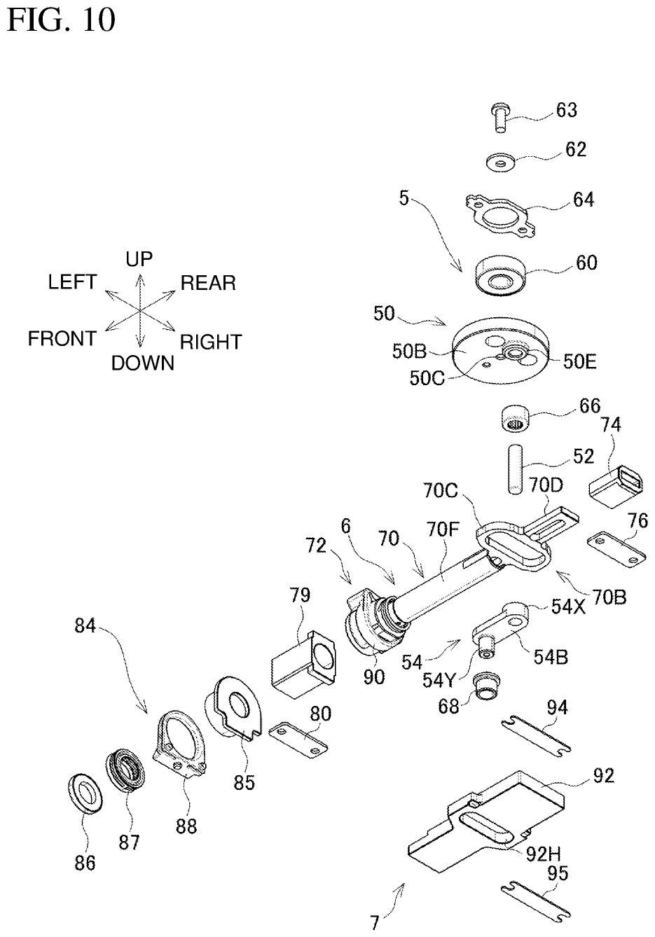

FIG. 9 is an exploded perspective view of the reciprocation transmitter 5 and the slider 6 as viewed from the upper left front. FIG. 10 is an exploded perspective view of the reciprocation transmitter 5 and the slider 6 as viewed from the lower left rear.

The reciprocation transmitter 5 is a power transmission for transmitting power from the motor 3 to the slider 6. The reciprocation transmitter 5 transmits rotational motion of the motor shaft 3S of the motor 3 to the slider 6. The slider 6 is movable in the front-rear direction. The reciprocation transmitter 5 is held by the gear case 8. The reciprocation transmitter 5 is located between the motor 3 and the slider 6. The reciprocation transmitter 5 is located below the motor 3.

The reciprocation transmitter 5 includes a gear 50 as a rotator, an eccentric shaft 52, and a crank 54.

The gear 50 includes a gear base 50B, a central cylinder 50C, and an eccentric cylinder 50E.

The horizontal-crank gear base 50B is a disk extending in the front-rear and lateral directions. The gear base 50B includes teeth (not shown) on its side surface. The gear base 50B meshes with the pinion gear 3G.

The central cylinder 50C is cylindrical and is located at the center of the gear base 50B. The central cylinder 50C has its upper portion protruding cylindrically upward from the gear base 50B. The central cylinder 50C extends through the upper rear opening of the gear case 8. An upper gear bearing 60 surrounds the central cylinder 50C. The upper gear bearing 60 supports the gear 50 in a rotatable manner. The upper gear bearing 60 includes an inner ring fastened to the central cylinder 50C with a washer 62 and a screw 63. The screw 63 is received in an upper portion of a hole of the central cylinder 50c receive. The upper gear bearing 60 includes an outer ring internally fastened to the upper rear opening of the gear case 8 with a plate-like upper gear bearing holder 64. The upper gear bearing holder 64 is fastened to the upper gear case 8U with multiple (left and right) vertical screws (not shown). The gear 50 rotates about an imaginary vertical rotation axis including its center in the front-rear and lateral directions. The rotation axis is parallel to the motor shaft centerline CM.

The eccentric cylinder 50E is cylindrical and is located at the periphery of the gear base 50B. The eccentric cylinder 50E has its lower portion protruding cylindrically downward from the periphery of the lower surface of the gear base 50B.

The gear 50 may be a pulley.

The eccentric shaft 52 is a cylindrical member. The eccentric shaft 52 has its upper portion extending through the eccentric cylinder 50E in the gear 50. The eccentric shaft 52 is connected to the gear 50. An eccentric bearing 66 is located outside a middle portion of the eccentric shaft 52.

The crank 54 includes a crank base 54B, a first crank cylinder 54X, and a second crank cylinder 54Y.

The crank base 54B is a plate extending in the front-rear and lateral directions and having short and long sides.

The first crank cylinder 54X is at a first end of the crank base 54B and extends upward from the crank base 54B. The first crank cylinder 54X receives a lower portion of the eccentric shaft 52.

The second crank cylinder 54Y is at a second end of the crank base 54B and extends downward from the crank base 54B. A cap 68 is placed over the second crank cylinder 54Y in a rotatable manner relative to the second crank cylinder 54Y.

The slider 6 includes a slider body 70 and a blade holder 72 as a tip tool holder. The slider 6 has its front end that can protrude from the front end of the gear case 8.

The slider body 70 includes a slider body front portion 70F and a slider body rear portion 70B. The slider body front portion 70F is a rod extending in the front-rear direction. The slider body rear portion 70B is a plate extending in the front-rear and lateral directions. This allows the slider 6 and its surroundings to be more compact than the structure including an entirely rod-like slider 6, while maintaining the blade holder 72 with rigidity.

The slider body rear portion 70B is joined to the rear end of the slider body front portion 70F. The slider body rear portion 70B includes a hole 70C and an extension 70D. The hole 70C is elongated laterally. The extension 70D is located behind the hole 70C. The extension 70D extends in the front-rear direction. The extension 70D has a lightening hole at the center. The lightening hole in the extension 70D may be eliminated. At least one of the size, number, or shape of the lightening hole in the extension 70D may be changed. The slider body front portion 70F may be cylindrical, hollow polygonal, or polygonal.

The hole 70C receives the eccentric shaft 52 and the eccentric bearing 66. The outer ring on the eccentric bearing 66 is in contact with the inner surface of the hole 70C. The eccentric shaft 52 is connected to the slider 6. This allows a more stable operation of the horizontal-crank reciprocating saw 1.

The eccentric shaft 52 and the eccentric bearing 66 rotate eccentrically as the gear 50 rotates. The motion of the eccentric shaft 52 and the eccentric bearing 66 includes a front-rear component causing the slider body 70 to reciprocate in the front-rear direction. The motion of the eccentric shaft 52 and the eccentric bearing 66 includes a lateral component causing the relative motion of eccentric shaft 52 and the eccentric bearing 66 within the hole 70C, and is not transmitted to the slider body 70.

A rear slider guide 74 surrounds the rear of the slider body rear portion 70B. The rear slider guide 74 is a hollow rectangular prism extending in the front-rear direction. The rear slider guide 74 is open frontward and rearward. The rear slider guide 74 is an oilless bearing. The rear slider guide 74 reciprocally receives the extension 70D in the slider body rear portion 70B. The rear slider guide 74 guides the extension 70D in the front-rear direction. The inner surface of the hole in the rear slider guide 74 is in contact with the outer surface of the extension 70D in a reciprocable manner. The rear slider guide 74 is held on the upper gear case 8U with a rear plate 76. The rear plate 76 is fastened to the upper gear case 8U with multiple (left and right) vertical screws 77 (FIGS. 3 and 7) with the rear plate 76 in contact with the lower surface of the rear slider guide 74. This allows a more stable reciprocating motion of the slider 6.

A front slider guide 79 surrounds the slider body front portion 70F. The front slider guide 79 is hollow and extends in the front-rear direction. The front slider guide 79 is open frontward and rearward. The front slider guide 79 has a prismatic outer shape. The front slider guide 79 has a cylindrical hole. The front slider guide 79 receives the slider body front portion 70F in a reciprocable manner. The front slider guide 79 guides the slider body front portion 70F in the front-rear direction. The inner surface of the hole in the front slider guide 79 is in contact with the outer surface of the slider body front portion 70F in a reciprocable manner. The front slider guide 79 is held on the upper gear case 8U with a front plate 80. The front plate 80 is fastened to the upper gear case 8U with multiple (left and right) vertical screws 81 (FIGS. 3 and 7) with the front plate 80 in contact with the lower surface of the front slider guide 79.

A seal 84 is located in front of the front slider guide 79. The seal 84 includes a holder 85, a front ring 86, a rear ring 87, and an outer ring 88.

The holder 85 includes a plate ring extending vertically and laterally, and a cylindrical portion extending frontward from its front surface.

The front ring 86 is an annular elastic member. The front ring 86 has a radially inner surface in contact with the outer surface of the slider body front portion 70F in a reciprocable manner. The front ring 86 has a radially outer surface in contact with the inner surface of the cylindrical portion of the holder 85.

The rear ring 87 is an annular elastic member. The rear ring 87 has an X-shaped cross section (e.g., FIG. 3). The rear ring 87 has a radially inner surface (two edges of the X shape radially inward) in contact with the outer surface of the slider body front portion 70F in a reciprocable manner. The rear ring 87 has a radially outer surface (two edges of the X shape radially outward) in contact with the inner surface of the cylindrical portion of the holder 85.

The holder 85 holds the front ring 86. The holder 85 holds the rear ring 87. The front ring 86 is in front of the rear ring 87.

The outer ring 88 is an annular elastic member. The outer ring 88 has a radially inner surface in contact with the outer surface of the cylindrical portion of the holder 85. The radially outer surface of the front ring 86 is in contact with an overall inner circumference of the front opening of the gear case 8. The holder 85 holds the outer ring 88.

The seal 84 is located at the front opening of the gear case 8. The seal 84 is held between the upper gear case 8U and the lower gear case 8D. The seal 84 seals between the gear case 8 and the slider body front portion 70F while allowing reciprocating movement of the slider body front portion 70F.

An outer seal 89 is located to seal between the front end of the gear case 8 and the front end of the body housing 2 (FIG. 3). The outer seal 89 is an annular elastic member. The outer seal 89 is located radially outward from the seal 84.

The blade holder 72 holds a blade B as a tip tool. The blade holder 72 automatically holds a blade B in response to the rear end of the blade B being simply inserted into the blade holder 72 (quick attachment).

The blade holder 72 is larger than the slider body 70 in the vertical and lateral directions. The slider 6 is an output unit. The blade B is a tip tool. The blade B is an elongated plate and extends in the front-rear direction when attached. The blade B has an edge BE on a longer side. The edge BE includes saw teeth. The blade B is attached with its edge BE facing downward. The blade B may be attached with its edge BE facing upward. The blade B may have edges BE on the two longer sides. The tip tool may be any tool other than the blade B.

The blade holder 72 includes a cam sleeve 90. The cam sleeve 90 is located in a radially outward portion of the blade holder 72. The cam sleeve 90 is rotatable about the slider centerline CS relative to a radially inner portion of the blade holder 72 to a predetermined angle. The blade B is removed (released) when the user rotates the cam sleeve 90 to a specific angle within the predetermined angle.

The counterweight 7 is combined with the reciprocation transmitter 5. The counterweight 7 is located below the reciprocation transmitter 5. The counterweight 7 is located opposite to the motor 3 with the slider 6 between them.

The counterweight 7 includes a metal balancer 92, an upper guide plate 94, and a lower guide plate 95. At least either the crank 54 or the cap 68 may be included in the counterweight 7 rather than in the reciprocation transmitter 5.

The balancer 92 is a plate extending in the front-rear and lateral directions. The balancer 92 includes a balancer hole 92H elongated laterally in a middle portion. The balancer 92 includes a portion rearward from the balancer hole 92H heavier than its portion frontward from the balancer hole 92H.

The balancer hole 92H in the balancer 92 receives the second crank cylinder 54Y on the crank 54 with the cap 68. The balancer 92 is connected to the crank 54.

The balancer 92 reciprocates in the front-rear direction as the gear 50 rotates. The cap 68 is located opposite to the eccentric shaft 52 and the eccentric bearing 66 with the center of the gear base 50B between them. More specifically, the cap 68 with the eccentric shaft 52 and the eccentric bearing 66 are at an angle of about 180° to the center of the gear base 50B in the front-rear and lateral directions. Thus, the balancer 92 moves in the direction directly opposite to the slider 6 in the front-rear direction. The balancer 92 thus reduces vibrations generated by the reciprocation of the slider 6. More specifically, the balancer 92 moves in the direction opposite to the backward and forward motion of the slider 6 and thus serves as a counterweight. The lateral component in the motion of the cap 68 and the second crank cylinder 54Y is the relative motion of the cap 68 and the second crank cylinder 54Y within the balancer hole 92H, and is not transmitted to the balancer 92.

The angle between the cap 68 with the second crank cylinder 54Y and the eccentric shaft 52 with the eccentric bearing 66 may be at an angle other than 180° (e.g., an angle between 160° and 200° other than 180°, or between 170° and 190° other than 180°). In this case, the balancer 92 moves in the direction substantially opposite to the slider 6 in the front-rear direction. The direction of the balancer 92 relative to the direction of the slider 6 is collectively referred to as the opposite direction, including the directly and the substantially opposite directions. The balancer 92 with lower eccentricity than the slider 6 may be better-balanced when heavier than the slider 6. The balancer 92 with higher eccentricity than the slider 6 may be better-balanced when lighter than the slider 6. This allows a more stable operation of the reciprocating saw 1 with the balancer 92.

The upper guide plate 94 is in contact with the rear of the upper surface of the balancer 92, while allowing the reciprocating movement of the balancer 92. The upper guide plate 94 has its left end engaged with a rear left pin 98 as shown mainly in FIGS. 4 and 7. The rear left pin 98 aligns the lower gear case 8D with the upper gear case 8U. The left end of the upper guide plate 94 is in contact with the lower surface of a pin holder 8BL for the rear left pin 98 in the upper gear case 8U. The upper guide plate 94 has its right end engaged with a rear right pin 98 as mainly shown in FIG. 4. The rear right pin 98 aligns the lower gear case 8D with the upper gear case 8U. The right end of the upper guide plate 94 is also in contact with the lower surface of a pin holder 8BR for the rear right pin 98 in the upper gear case 8U. In other words, at the left and right ends, the upper guide plate 94 is engaged with middle portions of the corresponding rear-left and rear-right pins 98 in the vertical direction. The middle portions are exposed in the gear case 8. The upper guide plate 94 is in contact with the left and right pin holders 8BL and 8BR. The upper guide plate 94 guides the balancer 92 in the front-rear direction.

The lower guide plate 95 is in contact with the rear of the lower surface of the balancer 92, while allowing the reciprocating movement of the balancer 92. The left end of the lower guide plate 95 is engaged with the rear left pin 98 as shown mainly in FIG. 4. The rear left pin 98 aligns the lower gear case 8D with the upper gear case 8U. The right end of the lower guide plate 95 is engaged with the rear right pin 98 as shown in FIG. 4. The rear right pin 98 aligns the lower gear case 8D with the upper gear case 8U. In other words, at the left and right ends, the lower guide plate 95 is engaged with lower middle portions of the corresponding rear-left and rear-right pins 98 in the vertical direction. The lower middle portions are exposed in the gear case 8. The lower guide plate 95 is in contact with the upper surface of a lower portion of the lower gear case 8D. More specifically, the lower guide plate 95 is in contact with the upper ends of multiple (three on the left, right, and middle) ribs 8F on the upper surface of the lower portion of the lower gear case 8D. The multiple ribs 8F (three on the left, right, and middle) are erected to protrude upward, and extend in the front-rear direction. The lower guide plate 95 guides the balancer 92 in the front-rear direction.

The balancer 92 held between the upper guide plate 94 and the lower guide plate 95 is more accurately guided in the front-rear direction. At least either the upper guide plate 94 or the lower guide plate 95 may be eliminated. A cylindrical guide may be located to guide the rear end of the balancer, in place of the upper guide plate 94 and the lower guide plate 95.

The guide shoe 9 is located adjacent to the blade B attached to the blade holder 72. The guide shoe 9 is located in front of and below the slider 6.

The guide shoe 9 includes a shoe plate 100, multiple (left and right) shoe supporters 102, and multiple (left and right) rivets 104.

The shoe plate 100 can be in contact with a workpiece. The shoe plate 100 has a hole elongated vertically in its center. The shoe plate 100 receives the attached blade B inside the hole.

The shoe supporters 102 are located on the right and left of the slider 6. The shoe supporters 102 are attached to the inner surface of the body housing 2.

Each rivet 104 is located at the front end of the corresponding shoe supporter 102. Each rivet 104 supports the shoe plate 100 in a swingable manner about the axis in the lateral direction.

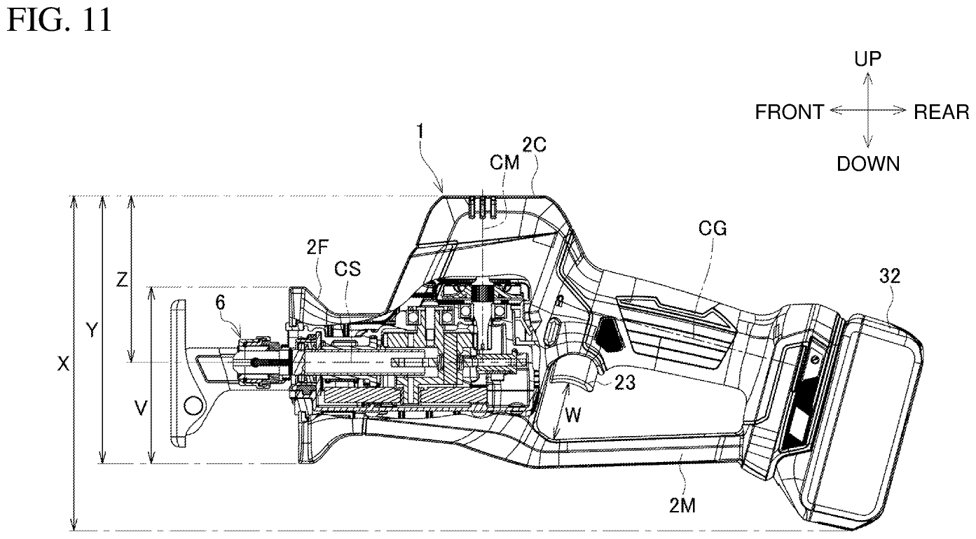

The dimensions of the reciprocating saw 1 will now be illustrated with reference to FIG. 11. The dimensions of the reciprocating saw 1 may be at least partially changed from the dimensions in the example below.

The reciprocating saw 1 has a dimension X of 182.0 mm in the direction of the motor shaft centerline CM from the upper end of the power housing 2C to the lower end of the battery 32. The reciprocating saw 1 has a dimension Y of 145.5 mm in the direction of the motor shaft centerline CM from the upper end of the power housing 2C to the lower end of the output housing 2F. The reciprocating saw 1 has a dimension Z of 90.5 mm in the direction of the motor shaft centerline CM from the upper end of the power housing 2C to the slider centerline CS. The motor shaft centerline CM is in the direction perpendicular to the slider centerline CS.

The reciprocating saw 1 has a dimension V of 96.0 mm in the direction of the motor shaft centerline CM from the upper end of the output housing 2F to the lower end of the output housing 2F.

The reciprocating saw 1 has a dimension W of 32.0 mm for a space from the middle of the trigger 23 in the front-rear direction to the front end of the connecting housing 2M, perpendicular to the grip centerline CG.

The reciprocating saw 1 may have dimensions in the ranges listed below. The dimensions of the reciprocating saw 1 may be at least partially changed from the dimensional ranges below.

The dimension X may be from 170 to 190 mm, inclusive. The dimension X may be from 175 to 185 mm, inclusive.

The dimension Y may be from 130 to 160 mm, inclusive. The dimension Y may be from 140 to 150 mm, inclusive.

The dimension Z may be from 75 to 100 mm, inclusive. The dimension Z may be from 85 to 95 mm, inclusive.

The dimension V may be from 85 to 110 mm, inclusive. The dimension Z may be from 90 to 100 mm, inclusive.

The total weight of the reciprocating saw 1 may be 3 kg or less. The total weight of the reciprocating saw 1 may be 2.8 kg or less. The total weight of the reciprocating saw 1 may be 2.6 kg or less. The total weight of the reciprocating saw 1 may be 2.4 kg or less. The stroke (forward and backward travel distance) of the slider 6 may be 20 mm or greater. The stroke of the slider 6 may be 22 mm or greater. The stroke of the slider 6 may be 24 mm or greater.

The voltage of the battery 32 may be rated at 18 V and may be up to 20 V. The voltage of the battery 32 may be rated at 36 V and may be up to 40 V.

The number of strokes per minute (min⁻¹) under no load in the slider 6 may be from 0 to 2500, inclusive. The number of strokes may be from 0 to 3000, inclusive. The number of strokes may be from 0 to 3500, inclusive.

The outer diameter (diameter) of the motor 3 may be 50 mm or greater. The outer diameter may be 53 mm or greater. The outer diameter may be 55 mm or greater.

An operation example of the reciprocating saw 1 will now be described.

The user attaches the blade B to the blade holder 72 in the slider 6 that is off through quick attachment. Typically, the blade B acts onto a workpiece from above. The blade B is thus attached with the edge BE (acting part) facing downward. The edge BE may be attached to face upward to, for example, allow the blade B to act onto the workpiece from below.

The user attaches the charged battery 32 to the battery housing 2P.

When the lock-off button 25 locks the trigger 23, the user operates the lock-off button 25 to unlock the trigger 23.

The user then places the front face of the guide shoe 9 onto a workpiece.

The user then holds the grip housing 2G (and the output housing 2F and the lower portion of the power housing 2C) and pulls the trigger 23 by a predetermined amount. This turns on the main switch body 24 and powers the motor 3 to rotate the motor shaft 3S. The motor 3 operates on DC power rectified through the control circuit board 29. The lamp 39 is turned on in response to the trigger 23 pulled by an amount exceeding a specified amount. The specified amount is smaller than the predetermined amount set for the motor 3 to be powered.

A microcomputer in the control circuit board 29 obtains information about the rotational state of the rotor 42. The microcomputer in the control circuit board 29 also controls the on-off state of each switching element in accordance with the obtained rotational state, and sequentially applies a current through the coils 40C in the stator 41 to rotate the rotor 42. The motor shaft 3S rotates at a rotational speed corresponding to a signal (the pull of the trigger 23) from the main switch body 24 in an on-state. The rotational speed of the motor shaft 3S is controllable by the control circuit board 29 to allow the motor shaft 3S to rotate at a higher rotational speed in correspondence with a larger pull of the trigger 23.

When the motor shaft 3S rotates, the gear 50 rotates via the pinion gear 3G, and the slider 6 reciprocates in the front-rear direction via the eccentric shaft 52, the eccentric bearing 66, and the hole 70C. The slider 6 guided by the rear slider guide 74 and the front slider guide 79 is restricted from moving in any direction other than the front-rear direction.

The balancer 92 reciprocates opposite to the slider 6 in the front-rear direction via the crank 54, the cap 68, and the balancer hole 92H. The slider 6 thus reciprocates with reduced vibrations. The balancer 92 guided by the upper guide plate 94 and the lower guide plate 95 (and the respective pins 98) is restricted from moving in any direction other than the front-rear direction.

As the user lowers the blade B toward a workpiece with the slider 6 or the blade B operating, the edge BE on the reciprocating blade B abuts against the workpiece and cuts the workpiece. The workpiece is mainly cut as the edge BE moves backward.

The reciprocating saw 1 with the connecting housing 2M in addition to the grip housing 2G has higher rigidity than the reciprocating saw 1 with the grip housing 2G alone. This allows stable operations of the reciprocating saw 1, and thus improves the quality of cutting of the workpiece. Additionally, the grip housing 2G (grip centerline CG) is inclined with respect to the slider 6 (slider centerline CS). Thus, this allows the user to press the blade B easily against the workpiece by gripping the grip housing 2G to cut the workpiece.

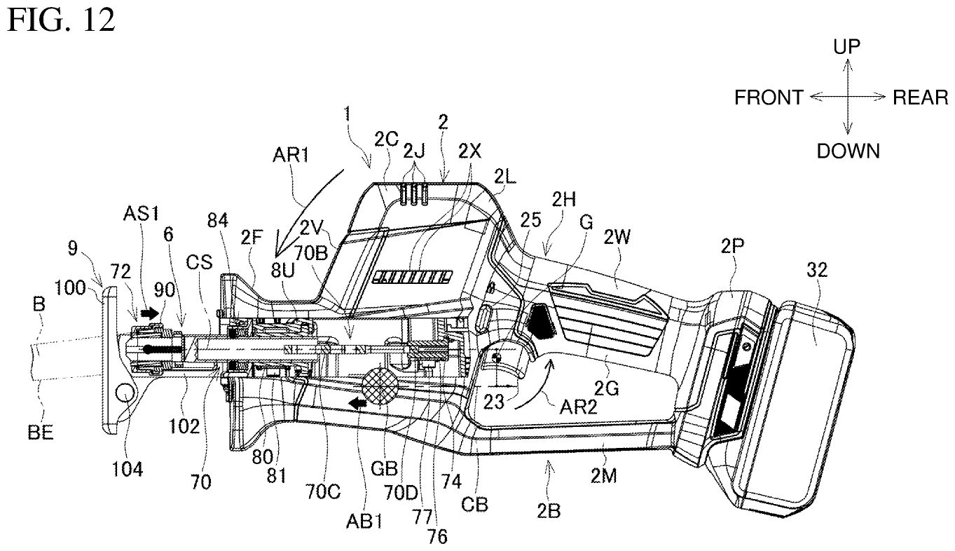

FIG. 12 is a partial cross-sectional left side view of the slider 6 moving backward near the front end of the reciprocating range of the slider 6 (refer to arrow AS1), or specifically, of the slider 6 starting moving backward. In this case, the slider centerline CS is located above the center of gravity G of the reciprocating saw 1 with the battery 32 attached. The center of gravity GB of the balancer 92 is located below the center of gravity G. The balancer 92 is located below the slider centerline CS and moves forward on a balancer centerline CB that is parallel to the slider centerline CS (refer to arrow AB1). More specifically, in the vertical direction, the distance between the balancer centerline CB and the center of gravity G is greater than the distance between the slider centerline CS and the center of gravity G. The balancer 92 has a weight defined based on the weight of the slider 6 (and blade B). Thus, a moment is generated counterclockwise as viewed from the left about the center of gravity G, as a reaction to the reciprocating motion of the slider 6 and the balancer 92. Thus, the reciprocating saw 1 receives a reaction to the action of every reciprocation of the slider 6 and the balancer 92 in a direction in which the edge BE moves downward (toward the workpiece) about the center of gravity G (refer to arrows AR1 and AR2). The balancer 92 may be heavier or lighter than the slider 6.

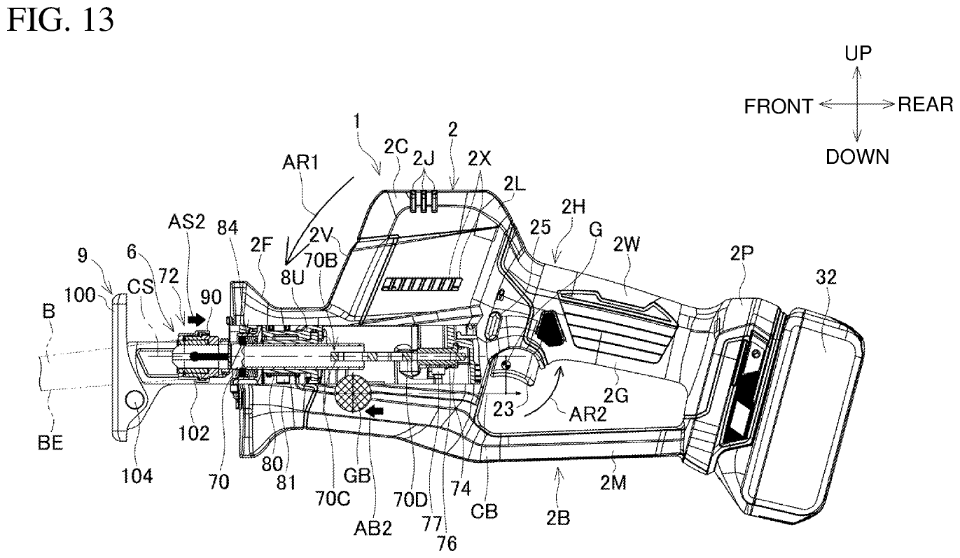

FIG. 13 is a partial cross-sectional left side view of the slider 6 moving backward near the rear end of the reciprocating range of the slider 6 (refer to arrow AS2), or specifically, of the slider 6 immediately before stopping moving backward. In this case, the slider centerline CS is located above the center of gravity G of the reciprocating saw 1. The center of gravity GB of the balancer 92 is located below the center of gravity G. The balancer 92 is located below the slider centerline CS and moves forward on the balancer centerline CB that is parallel to the slider centerline CS (refer to arrow AB2). Thus, the reciprocating saw 1 receives a reaction to the action of every reciprocation of the slider 6 and the balancer 92 in a direction in which the edge BE moves downward (toward the workpiece) about the center of gravity G (refer to arrows AR1 and AR2).

During movement of the slider 6 backward between the states in FIGS. 12 and 13, the reciprocating saw 1 receives a reaction force in the direction of arrows AR1 and AR2. Thus, the reciprocating saw 1 receives a reaction force in a direction in which the edge BE acts onto the workpiece when the edge BE, which mainly performs the cutting action, moves backward. This allows the reciprocating saw 1 to process the workpiece more easily, thus improving the processing speed of the workpiece.

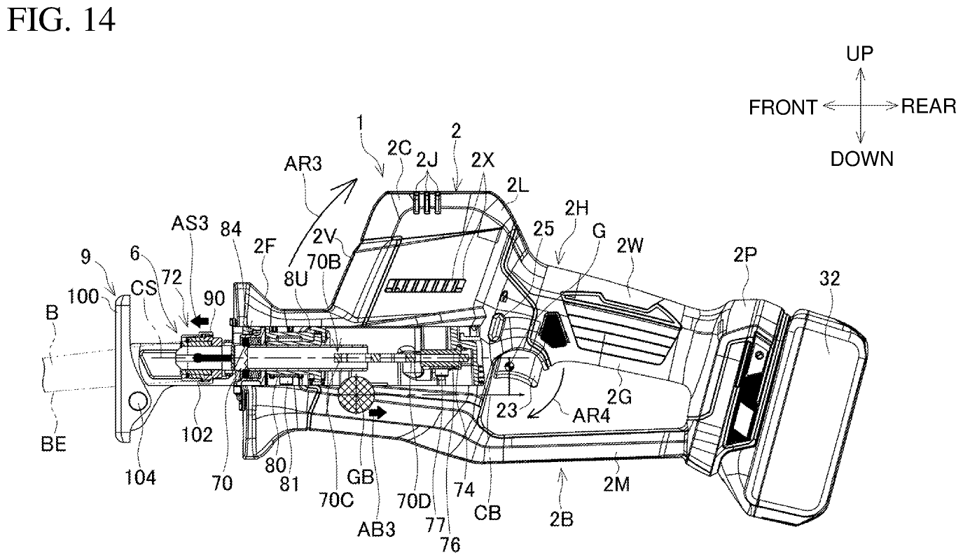

FIG. 14 is a partial cross-sectional left side view of the slider 6 moving forward near the rear end of the reciprocating range of the slider 6 (refer to arrow AS3), or specifically, of the slider 6 starting moving forward. In this case, the slider centerline CS is located above the center of gravity G of the reciprocating saw 1. The center of gravity GB of the balancer 92 is located below the center of gravity G. The balancer 92 is located below the slider centerline CS and moves backward on the balancer centerline CB that is parallel to the slider centerline CS (refer to arrow AB3). More specifically, in the vertical direction, the distance between the balancer centerline CB and the center of gravity G is greater than the distance between the slider centerline CS and the center of gravity G. The balancer 92 has a weight defined based on the weight of the slider 6 (and blade B). Thus, a moment is generated clockwise as viewed from the left about the center of gravity G, as a reaction to the reciprocating motion of the slider 6 and the balancer 92. Thus, the reciprocating saw 1 receives a reaction force to the action of every reciprocation of the slider 6 and the balancer 92 in a direction in which the edge BE moves upward (opposite to the workpiece) about the center of gravity G (refer to arrows AR3 and AR4).

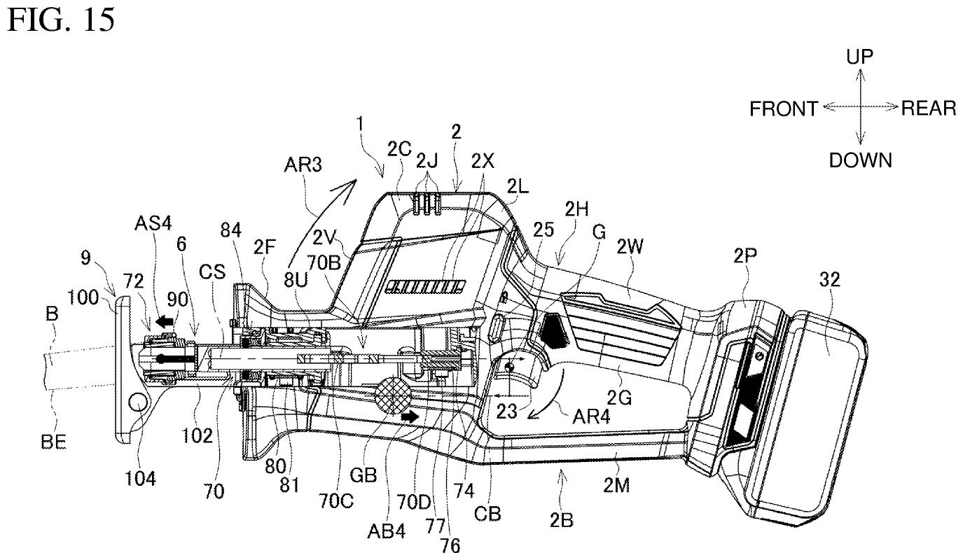

FIG. 15 is a partial cross-sectional left side view of the slider 6 moving forward near the front end of the reciprocating range of the slider 6 (refer to arrow AS4), or specifically, of the slider 6 immediately before stopping moving forward. In this case, the slider centerline CS is located above the center of gravity G of the reciprocating saw 1. The center of gravity GB of the balancer 92 is located below the center of gravity G. The balancer 92 is located below the slider centerline CS and moves backward on the balancer centerline CB that is parallel to the slider centerline CS (refer to arrow AB4). More specifically, in the vertical direction, the distance between the balancer centerline CB and the center of gravity G is greater than the distance between the slider centerline CS and the center of gravity G. Thus, a moment is generated clockwise as viewed from the left about the center of gravity G, as a reaction to the reciprocating motion of the slider 6 and the balancer 92. Thus, the reciprocating saw 1 receives a reaction to the action of every reciprocation of the slider 6 and the balancer 92 in a direction in which the edge BE moves upward about the center of gravity G (refer to arrows AR3 and AR4).

During movement of the slider 6 forward between the states in FIGS. 14 and 15, the reciprocating saw 1 receives a reaction force in the direction of arrows AR3 and AR4. In other words, unlike when the edge BE moves backward, the workpiece receives a reaction force acting opposite to the edge BE from the workpiece when the edge BE moves forward without cutting the workpiece.

Except the above states, for example, when the center of gravity GB of the balancer 92 is located above the center of gravity G of the reciprocating saw 1, the reaction force is not in a direction in which the blade acts onto the workpiece when the slider 6 moves backward as described above. More specifically, in the vertical direction, the distance between the balancer centerline CB and the center of gravity G is greater than the distance between the slider centerline CS and the center of gravity G. The balancer 92 has a predetermined weight defined based on the weight of the slider 6 (and blade B) to reduce vibrations. Thus, a moment is generated clockwise as viewed from the left about the center of gravity G, as a reaction to the reciprocating motion of the slider 6 and the balancer 92, when the slider 6 moves backward.

As the fan 4 rotates with rotation of the motor shaft 3S, the air around the fan 4 is forced radially outward. Thus, an air flow (blow) is generated in the body housing 2 to cool the various components in the body housing 2.

In particular, part of the blow flows through the left inlets 2J and the right inlets 2K on the upper end of the power housing 2C to radially outward from the stator 41 in the motor 3 and between the stator 41 and the rotor 42. The motor 3 is thus cooled efficiently.

In response to the user turning off the main switch body 24 by operating the trigger 23, the rotor 42 (motor shaft 3S) is stopped to stop reciprocations and air flow. In addition, the lamp 39 is turned off after a predetermined time period as controlled by the control circuit board 29.

The blade B attached to the blade holder 72 is removed in response to the user rotating the cam sleeve 90 in the blade holder 72 while the slider 6 is stopped.

The embodiments and modifications of the present disclosure are not limited to the embodiments described above. For example, the embodiments and modifications may be further changed as appropriate as described below.

The connecting housing 2M may connect the power housing 2C to the rear of the grip housing 2G, in place of connecting the power housing 2C to the battery housing 2P. In this case as well, the connecting housing 2M increases the rigidity of the reciprocating saw 1 and allows a more stable operation.

The reciprocating saw 1 may include an orbital unit. The orbital unit acts on the slider 6 to allow the blade holder 72 to perform an orbital action (trajectory motion). The orbital action follows a predetermined trajectory such as an elliptical trajectory, a semi-elliptical trajectory, or a semi-elliptical arc reciprocating trajectory (swing trajectory). The reciprocating saw 1 may also include an orbital switch that switches the orbital actions (trajectory).

The reciprocation transmitter 5 may be replaced with another component. The reciprocation transmitter 5 may include, for example, an intermediate gear between the gear 50 and the pinion gear 3G. A connecting rod may also be placed between the gear 50 and the slider 6.

Needle bearings may be used in place of ball bearings, or ball bearings may be used in place of needle bearings. The number of the attachable battery 32 may be multiple. In addition, at least one of the components may be eliminated, or the number of components, their materials, shapes, types, and arrangement may be changed variously.

The tip tool may be any tool other than the blade B.

In place of the battery 32, a power cable may be used to supply power. The power cable may be connected to utility power.

The embodiments and their modifications are applicable to reciprocating cutting tools other than the reciprocating saw 1 (e.g., a jigsaw), reciprocating tools other than reciprocating cutting tools, power tools, gardening tools, and electric work machines.

### REFERENCE SIGNS LIST

1 reciprocating saw (reciprocating cutting tool)
2 body housing
2C power housing
2G grip housing
2L left body housing (half)
2M connecting housing
2P battery housing
2R right body housing (half)
3 motor (brushless motor)
5 reciprocation transmitter
6 slider
16 screw
50 gear (rotator)
52 eccentric shaft
54 crank
70 slider body
70B slider body rear portion
70C hole
70F slider body front portion
72 blade holder (tip tool holder)
74 rear slider guide
92 balancer
B blade (tip tool)
BE edge (acting part)
CB balancer centerline (imaginary balancer centerline)
CG grip centerline
CM motor shaft centerline
CS slider centerline
G center of gravity (of the reciprocating saw)

What is claimed is:

1. A reciprocating cutting tool, comprising:
a motor extending vertically;
a reciprocating transmitter located below the motor;
a slider extending in a front-rear direction, connected to the reciprocation transmitter, and movable in the front-rear direction;
a power housing holding the motor and the reciprocation transmitter;
a grip housing extending rearward from the power housing;
a battery housing located behind the grip housing; and
a connecting housing located below the grip housing and connecting the power housing to the battery housing.

2. A reciprocating cutting tool, comprising:
a brushless motor extending vertically;
a reciprocation transmitter located below the brushless motor;
a slider extending in a front-rear direction, connected to the reciprocation transmitter, and movable in the front-rear direction;
a power housing holding the brushless motor and the reciprocation transmitter;
a grip housing extending rearward from the power housing; and
a connecting housing located below the grip housing and connecting the power housing to the grip housing.

3. The reciprocating cutting tool according to claim 1, wherein
the grip housing has a grip centerline as an imaginary centerline angled to face upward with respect to a slider centerline as an imaginary centerline of the slider.

4. The reciprocating cutting tool according to claim 1, wherein
the motor includes a motor shaft, and
the motor shaft has a motor shaft centerline as an imaginary centerline perpendicular to a slider centerline as an imaginary centerline of the slider.

5. The reciprocating cutting tool according to claim 1, wherein
the connecting housing is angled to face downward with respect to a slider centerline as an imaginary centerline of the slider.

6. The reciprocating cutting tool according to claim 1, wherein
the connecting housing includes connecting housing halves, and
the connecting housing includes a screw coupling the connecting housing halves together.

7. The reciprocating cutting tool according to claim 1, wherein
the reciprocation transmitter includes a rotator extending in the front-rear direction and in a lateral direction.

8. The reciprocating cutting tool according to claim 7, further comprising:
an eccentric shaft connected to the rotator.

9. The reciprocating cutting tool according to claim 8, wherein
the eccentric shaft is connected to the slider.

10. The reciprocating cutting tool according to claim 1, further comprising:
a balancer connected to the reciprocation transmitter and movable in a direction opposite to the slider in the front-rear direction.

11. The reciprocating cutting tool according to claim 10, wherein
the balancer is located below the reciprocation transmitter.

12. The reciprocating cutting tool according to claim 10, wherein
the reciprocation transmitter includes a rotator extending in the front-rear direction and in a lateral direction,
the reciprocating cutting tool further comprises
an eccentric shaft connected to the rotator, and
a crank connected to the eccentric shaft, and
the balancer is connected to the crank.

13. The reciprocating cutting tool according to claim 10, wherein
the balancer is heavier than the slider.

14. The reciprocating cutting tool according to claim 10, wherein
the balancer is lighter than the slider.

15. The reciprocating cutting tool according to claim 1, wherein
the slider includes a slider body, and
the slider body includes
a slider body front portion being a rod and located in a front portion of the slider body, and
a slider body rear portion being a plate extending in the front-rear direction and in a lateral direction and located in a rear portion of the slider body.

16. The reciprocating cutting tool according to claim 15, wherein
the reciprocation transmitter includes a rotator extending in the front-rear direction and in the lateral direction,
the reciprocating cutting tool further comprises an eccentric shaft connected to the rotator, and
the slider body rear portion has a hole receiving the eccentric shaft.

17. The reciprocating cutting tool according to claim 15, further comprising:
a rear slider guide to guide the slider body rear portion.

18. A reciprocating cutting tool, comprising:
a slider extending in a front-rear direction, the slider including a tip tool holder to hold a tip tool including an acting part to act onto a workpiece, the tip tool holder being configured to hold the tip tool with the acting part facing at least upward or downward;
a motor;
a reciprocation transmitter connected to the motor and the slider to move the slider in the front-rear direction, the reciprocation transmitter including a rotator extending in the front-rear direction and in a lateral direction; and
a balancer connected to the reciprocation transmitter, movable in a direction opposite to the slider in the front-rear direction, and having a predetermined weight,
wherein in a vertical direction, a distance between an imaginary centerline of the balancer and a center of gravity of the reciprocating cutting tool is greater than a distance between an imaginary centerline of the slider and the center of gravity.

19. The reciprocating cutting tool according to claim 18, further comprising:
an eccentric shaft connected to the rotator,
wherein the eccentric shaft is connected to the slider,
the slider is located above the center of gravity,
the balancer is located below the center of gravity, and
the reciprocating cutting tool further comprises
a power housing holding the motor and the reciprocation transmitter,
a grip housing extending rearward from the power housing,
a battery housing located behind the grip housing, and
a connecting housing located below the grip housing and connecting the power housing to the battery housing.

20. The reciprocating cutting tool according to claim 18, further comprising:
an eccentric shaft connected to the rotator,
wherein the eccentric shaft is connected to the slider,
the slider is located above the center of gravity,
the balancer is located below the center of gravity, and
the reciprocating cutting tool further comprises
a power housing holding the motor and the reciprocation transmitter,
a grip housing extending rearward from the power housing, and
a connecting housing located below the grip housing and connecting the power housing to a rear portion of the grip housing.
